(19) United States
(12) Patent Application Publication
(10) Pub. No.: US 2011/0043359 A1
(43) Pub. Date: Feb. 24, 2011

(54) TODDLER SAFETY BED ALARM

(76) Inventor: ASHLEY TOLER, Bolt, WV (US)

Correspondence Address: LAW OFFICE OF JERRY D. HAYNES , P.A, P.O. Box 350392, Fort Lauderdale, FL, 33335, US

(21) Appl. No.: 12/545,965

(22) Filed: Aug. 24, 2009

(51) Int. Cl. G08B 1/08

(52) U.S. Cl. 340/539.15

(57) ABSTRACT

The present invention relates to a child safety bed alarm system comprising: a bed alert pad, where the pad is inserted within the bed sheets of a bed and is powered by a battery; at least one of a pressure sensor and a motion sensor within the alert pad; a mechanism to transmit a RF signal within the alert pad; and a central alarm receiver, where the central alarm receiver receives the RF signal from the alert pad upon the activation thereof by the at least one of pressure sensor and motion sensor within the alert pad and the alarm receiver emits an audible alarm upon receipt of the RF signal, where the alarm receiver is powered by at least one of a battery and an AC current power supply. The RF signal is activated upon the movement of child from the bed.

### BACKGROUND OF THE INVENTION

1. Field of Invention

The present invention provides an alarm system to be utilized to alert a parent or guardian of the movement of a toddler out of a bed.

2. Description of Related Art

Toddlers may asleep in the various types of beds and in particular infants begin sleeping in a crib initially, which provides adequate protection for the child. A baby crib is usually comprised of four sides where each side includes vertical bars positioned between a top and bottom molding. One or more of the sides of the crib are usually displaceable meaning that a gate exists that can be lowered to provide a means to place the infant into the crib and to remove the infant from the crib as desired. The gate is kept in the up position and the crib is enclosed therefore preventing the infant from climbing out of the crib and possibly injuring themselves.

As the child grows into the toddler stage eventually the toddler is removed from the crib and usually placed in a small twin bed for sleeping purposes. Although a toddler may not have problems in climbing into and out of the bed, parents must be alert of their child's activity if the bedroom is on a second floor area or in another area where it may not be safe for the toddler to move about without parental supervision.

Once a toddler is sleeping in a twin-size bed it would be advantageous to have an alerting system that may alert a parent of the toddler's movement out of the bed and therefore enables them to properly supervise the child. Such a device may prevent the child from encountering hazards or wandering about unsupervised.

### SUMMARY OF THE INVENTION

The present invention relates to a child safety bed alarm system comprising: a bed alert pad, where said pad is inserted within the bed sheets of a bed and is powered by a battery; at least one of a pressure sensor and a motion sensor within the alert pad; a means to transmit a RF signal within the alert pad; and a central alarm receiver, where said central alarm receiver receives the RF signal from the alert pad upon the activation thereof by the at least one of pressure sensor and motion sensor within the alert pad and said alarm receiver emits an audible alarm upon receipt of the RF signal, where said alarm receiver is powered by at least one of a battery and an AC current power supply. The RF signal is activated upon the movement of child from the bed. The child safety bed alarm system may also include a handheld alarm receiver that receives the RF signal from the alert pad upon the activation thereof by the pressure sensor or motion sensor within the alert pad. The alarm receiver emits an audible alarm upon receipt of the RF signal and may be powered by a battery.

### BRIEF DESCRIPTION OF DRAWINGS

FIG. 1 (a) depicts a handheld alarm receiver e according to the present invention.

FIG. 1 (b) depicts a bed alert pad according to the present invention.

FIG. 2 depicts a central alarm receiver according to the present invention.

### DETAILED DESCRIPTION

The present invention relates to a child safety bed alarm that enables a parent or guardian to monitor the sleep and movement of a child in a bed. The child safety bed alarm according to the present invention includes an alarm pad that is placed within the sheets of a child's bed that transmits an alert upon the movement of a child out of the bed.

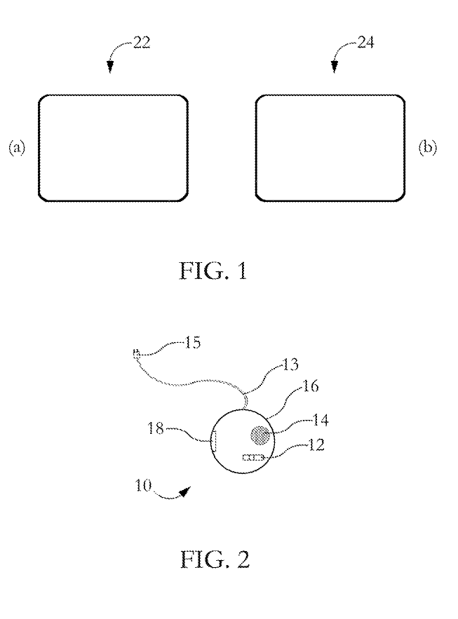

The FIG. 1 depicts a bed alert pad 24 and a handheld alarm receiver 22. As contemplated by the present invention the alert pad 24 is a soft cotton covered alerting pad that is placed within the sheets of a toddler's bed. The alert pad 24 includes motion and pressure sensors that are able to detect movement of the toddler out of the bed after being activated by the parent. The alert pad 24 is used in conjunction with the handheld alarm receiver 22 and a central alarm receiver 10, which is depicted in FIG. 2.

The alert pad 24 transmits a RF signal to the central alarm receiver 10 and the handheld alarm receiver 22 when the child or toddler leaves the bed and therefore activates the alerting sensors within the alert pad 24. The sensors within the alert pad 24 are capable of sensing the pressure and weight of the toddler while the toddler is laying within the bed. Once the toddler or child leaves the bed, the sensors are triggered due to the lack of pressure of the child laying in the bed. Once the alert pad 24 is triggered a signal is provided to the alarm receiver 10.

The alarm receiver 10 includes an audible speaker 14 and may be operated either through the use of batteries that are inserted in a battery compartment 18 or plugged directly into the wall using AC current. A plug 15 and an electrical cord 13 are provided to supply the alarm receiver 10 with power. Other components of the alarm receiver 10 include an on/off switch 12 and a volume control 16. This alarm receiver 10 may be placed within the parent's room and therefore keep them alert through an electronic means of the whereabouts of their toddler while the toddler should be sleeping.

In addition to the central alarm receiver 10, the present invention contemplates the use of a handheld alarm receiver 22 that has been depicted in FIG. 1. The handheld alarm receiver 22 allows the parent to receive a signal while keeping the handheld alarm receiver 22 on their person. Many times children will go to sleep at an earlier time in the evening than their adult parents and therefore the use of the handheld alarm receiver 22 allows the parents to roam around the house or to be at least away from the central alarm receiver 10 but yet receive notice of the movement of the child out of the bed.

The bed alarm system according to the present invention provides a means to alert parents should the children leave their bed and therefore prevent toddlers from wandering about unsupervised. The motion sensors provided in the alert pad 24 help to signal and monitor the activity of the toddler once he or she is placed in the bed for sleeping. The bed alarm system according to the present invention provides the parents with the security to know when their child is getting out of the bed and also to prevent any accidents or injuries occurring to the child.

The instant invention has been shown and described in what is considered to be the most practical and preferred embodiments. It is recognized, however, that departures may be made there from within the scope of the invention and that obvious modifications will occur to a person skilled in the art.

What is claimed is:

1. A child safety bed alarm system comprising:
a. a bed alert pad, where said pad is inserted within the bed sheets of a bed and is powered by a battery;
b. at least one of a pressure sensor and a motion sensor within the alert pad;
c. a means to transmit a RF signal within the alert pad; and
d. a central alarm receiver, where said central alarm receiver receives the RF signal from the alert pad upon the activation thereof by the at least one of pressure sensor and motion sensor within the alert pad and said alarm receiver emits an audible alarm upon receipt of the RF signal, and said alarm receiver is powered by at least one of a battery and an AC current power supply.

2. The child safety bed alarm system according to claim 1, where said RF signal is activated upon the movement of child from the bed.

3. The child safety bed alarm system according to claim 1, further comprising a handheld alarm receiver where said handheld alarm receiver receives the RF signal from the alert pad upon the activation thereof by the at least one of pressure sensor and motion sensor within the alert pad and said alarm receiver emits an audible alarm upon receipt of the RF signal and said handheld alarm receiver is powered by a battery.

4. The child safety bed alarm system according to claim 1, where the at least one of pressure sensor and motion sensor within the alert pad is capable of sensing the pressure and weight of a child laying the bed and said at least one of pressure sensor and motion sensor within the alert pad trigger the transmission of the RF signal upon the movement of the child out of the bed.

5. The child safety bed alarm system according to claim 1, wherein said alarm receiver includes an audible speaker and an on/off switch.

6. The child safety bed alarm system according to claim 3, wherein said handheld alarm receiver includes an audible speaker.

7. The child safety bed alarm system according to claim 1, wherein said alert pad includes a soft cotton covering.
